(19) United States
(12) Patent Application Publication
(10) Pub. No.: US 2012/0308763 A1
(43) Pub. Date: Dec. 6, 2012

(54) ADHESIVE FASTENING DEVICE

(76) Inventor: Albert CHEN, Los Angeles, CA (US)

(21) Appl. No.: 13/225,420

(22) Filed: Sep. 3, 2011

Related U.S. Application Data
(63) Continuation-in-part of application No. 13/152,312, filed on Jun. 3, 2011.
Application No. 13/152,312 is a continuation-in-part of application No. 13/209,404, filed on Aug. 14, 2011.

(51) Int. Cl. B32B 3/06; C09J 7/02; B32B 3/10

(52) U.S. Cl. 428/78

(57) ABSTRACT

The disclosure is an adhesive fastening or supporting device that employs a unique and effective polymer adhesive material, and includes use-indicative graphics. The device is temporarily or permanently adherable to most flat vertical surfaces and is removable there-from for re-use many times, without leaving residue on or damage to the surface. The disposition of the device's fastening or supporting element inboard of the device's perimeter together with the relative flexibilities of the device's various components, reduces inadvertent peeling of the device from the wall and improves intentional peeling.

### RELATED APPLICATION

This application is a Continuation-in-Part of pending U.S. Utility patent application Ser. No. 13/152,312 filed on Jun. 7, 2011, and U.S. Utility patent application Ser. No. 13/209,404, filed on Aug. 14, 2011, the entire teachings thereof being incorporated herein by reference.

### FIELD OF THE INVENTION

The present invention is generally related to adhesive fastening devices, including but not limited to utility hooks. More specifically, the field of the invention as embodied in the present disclosure is related to a fastening device, shown in the preferred embodiment as a hooking device, that is adhesive to most flat surfaces, removable there-from without leaving residue behind, and reusable. Even more specifically, the field of the invention as embodied in the present disclosure is related to such a fastening device that employs a unique and effective polymer adhesive material, is designed to avoid inadvertent removal from flat surfaces while improving intentional removal, and includes graphics indicative of its intended use.

### SUMMARY OF THE INVENTION

The invention may be embodied as an hook or other fastening element or supporting element having an adhesive backing made of an oil-enhanced thermoplastic rubber polymer material, or similar material, to provide adherence to a multitude of various surfaces, to be removable there-from without leaving residue behind, and for a virtually infinite number of future re-adherences to other surfaces. The fastening element may include a hook, post, clip, shelf, or other fastening or supporting element shaped or otherwise adapted to temporarily receive and support a variety of potential objects. The adhesive backing may be permanently bonded to the fastening element, and may have sufficient adherence to the surface to support the weight of anticipated objects without inadvertent release from the surface. This adherence may be enhanced by the construction of the fastening element and its relationship to the adhesive backing to reduce the likelihood of inadvertent peeling of the device from the surface. For instance, the fastening element may be disposed centrally relative to the perimeter of the adhesive backing so that the weight of the supported object or other forces acting on the fastening element during use do not promote peeling of the adhesive backing near to its perimetrical edge. Yet the device selectively removed from the surface by intentional peeling at the perimetrical edge without leaving any residue or damage to the surface, and may be re-adhered to other surfaces thereafter without significant loss of adherence.

As an example, the invention may be embodied in an adhesive supporting device having: an adhesive pad with an adhesive rear face for adherence to a surface and a flexible front face, the adhesive pad having a pad perimeter; a supporting element comprising a support and a substantially rigid backing plate integrally formed therewith or bound thereto, the backing plate having a plate perimeter smaller than the pad perimeter and a rear plate face permanently bound approximately centrally to the flexible front face of the adhesive pad such that the plate perimeter is inboard of the pad perimeter.

This adhesive supporting device may further include a graphic sheet bound to the flexible front face. The graphic sheet may include graphics or text that indicates an object that the support is adapted to support.

This support may be one from the group including a hook, a post, a clip, a hanger, and a shelf. This pad may include an elastomeric rear adhesive layer comprising the adhesive rear face, and a flexible front layer permanently laminated thereto and comprising the flexible front face. This flexible front layer may be less flexible than the elastomeric rear adhesive layer and more flexible than the substantially rigid backing plate. This support and the backing plate may be integrally formed of a same material.

As another example, the invention may be embodied in an adhesive fastening device having: an adhesive pad with an adhesive rear face for adherence to a surface and a flexible front face, the adhesive pad having a pad perimeter; a fastening element comprising a fastener, and a substantially rigid backing plate integrally formed therewith or bound thereto, the backing plate having a plate perimeter smaller than the pad perimeter and a rear plate face permanently bound approximately centrally to the flexible front face of the adhesive pad such that the plate perimeter is inboard of the pad perimeter.

This adhesive fastening device may further include a graphic sheet bound to the flexible front face. The graphic sheet may include graphics or text that indicates an object that the fastener is adapted to receive.

This fastener may be a hook. This pad may include an elastomeric rear adhesive layer comprising the adhesive rear face, and a flexible front layer permanently laminated thereto and comprising the flexible front face. This flexible front layer may be less flexible than the elastomeric rear adhesive layer and more flexible than the substantially rigid backing plate. This hook and the backing plate may be integrally formed of a same material.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings showing the representative embodiment of the accompanying Detailed Description. The components in the drawings are not necessarily to scale, emphasis instead being placed upon clearly illustrating the principles of the invention. Moreover, in the drawings, like reference numerals designate corresponding parts throughout the several views.

FIG. 1 is a perspective view of an adhesive fastening device according to an exemplary embodiment of the invention;

FIG. 2 is a front view of the adhesive fastening device of FIG. 1, having an object hung there-from;

FIG. 3 is a cross-sectional side view of the adhesive fastening device of FIG. 1, adhered to a vertical surface, and having the object hung there-from;

FIG. 4 is an exploded perspective view of the adhesive fastening device of FIG. 1;

FIG. 5 is a top view of the adhesive fastening device of FIG. 1, adhered to a vertical surface, and having the object hung there-from; and

FIG. 6 is an exploded side view of the adhesive fastening device of FIG. 1.

### DETAILED DESCRIPTION OF A REPRESENTATIVE EMBODIMENT

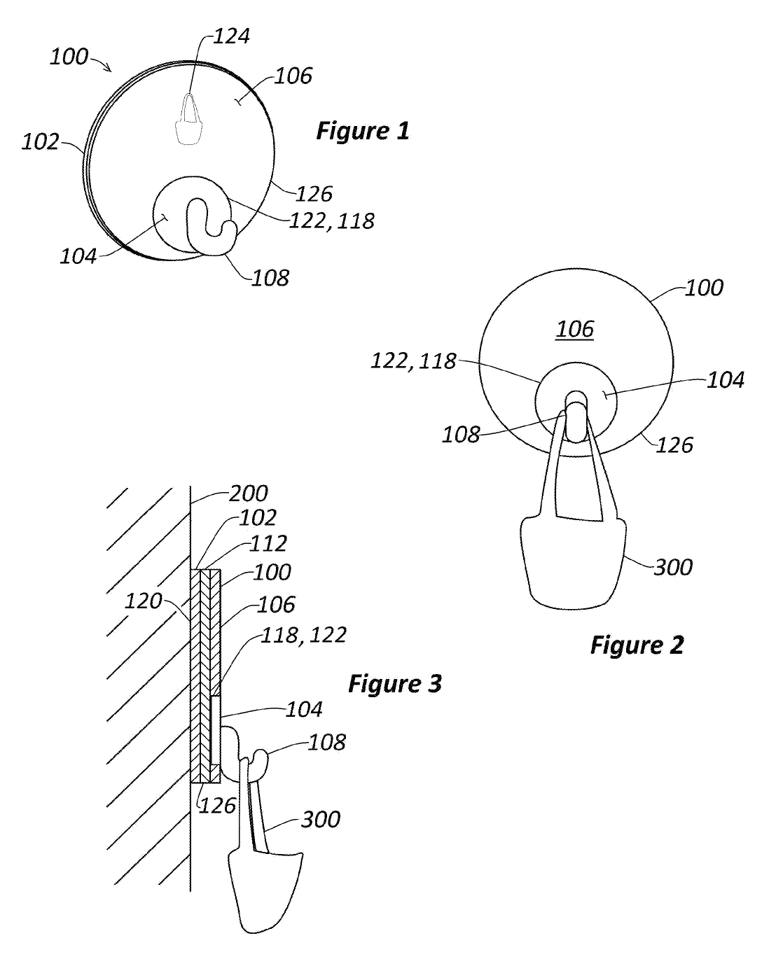

An adhesive fastening device 100 exemplary of the invention is shown in FIGS. 1-6. The device comprises a backing sheet 110, a pad 114 in the form of a more flexible rear adhesive layer 102 and a less flexible middle layer 112, a graphic sheet 106, and a fastening element 116 in the form of faster 108 and a backing plate 104. The backing sheet, pad, and graphic sheet are laminated together, as later described, and have the same aligned perimeter. This shared perimeter 126 as depicted is approximately four inches in diameter, and may be created by aligning the sheets after they are all punched or otherwise formed, or may be created by laminating larger layers first, then punching through the layers all at once.

The preferred fastener 108, as depicted, is a hook, from which objects such as purse 300 may be hung. However, the fastener could also take the form of a post, a clip, a hanger, a shelf, or any such fastening or supporting means according to the object(s) intended to be received thereby, within the intended scope of the invention.

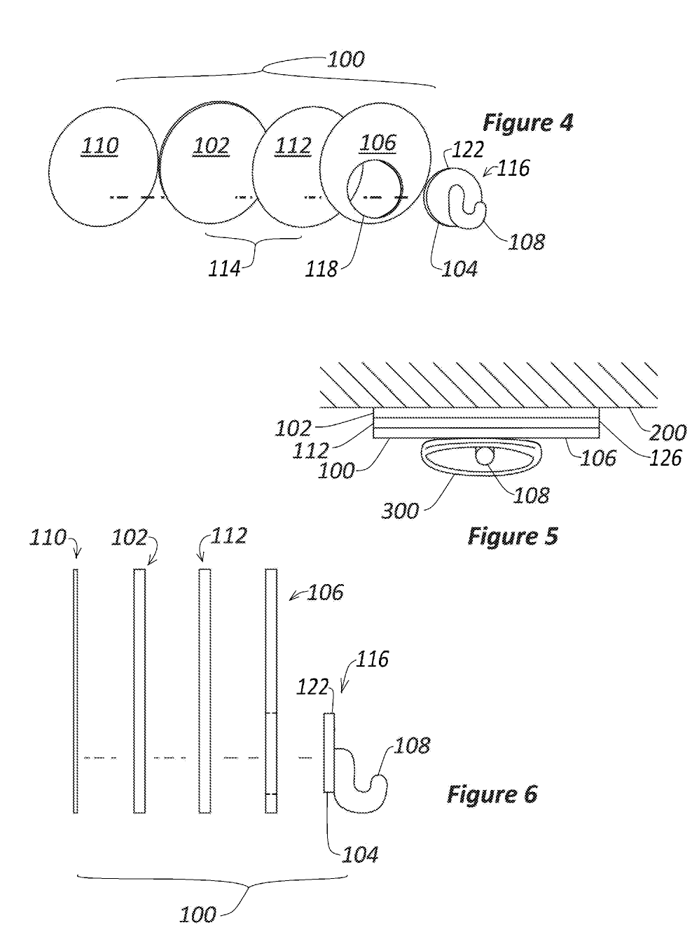

The fastening device is shown in FIGS. 1 and 4 with its backing sheet 110 included, as it is packaged for shipping. The backing sheet is removed prior to adherence of the fastening device to a surface, such as vertical wall 200. The fastening device is shown in FIGS. 3 and 5 with its backing sheet removed and its adhesive rear face 120 adhered to an arbitrary surface, in this case wall 200.

The backing sheet is preferably a wax or silicone impregnated paper material or a plastic film that removably adheres to the pad equivalently to the intended adherence of the pad to other surfaces, so that the backing sheet can be applied at manufacturing and can protect the pad during shipping, and can then be easily peeled from the pad prior to sticking the pad to a surface. No glue is used between the backing sheet and pad, so that the backing layer adheres to the pad by the adhesive properties of the pad only, and is easily peelable there-from. PET, PP, and PE films are also found to be acceptable materials for the backing sheet. The backing sheet is removed and disposed of just prior to adhering the fastening device to the intended surface, or it may be saved and re-applied between uses of the fastening device on different surfaces.

The fastener 108 and backing plate 104 are preferably formed of the same polymers, or at least of co-bondable materials, either as a single integral component, or as two components permanently bonded together such as by gluing, solvent welding, ultrasonic welding, etc. The backing plate has a perimeter 122, which in this case is approximately two inches in diameter. Chosen materials for the fastening element include ABS, polystyrene, or polycarbonate, both because of the structural properties of these polymers, and because of their amenability to bonding together by such techniques.

As seen best in FIGS. 1 and 2, the graphics sheet 106 is highly visible during use. It may be made of most any polymer film suitable for having graphics printed thereon, such as polycarbonate (PC) or poly-vinyl-chloride (PVC), or embedded therein, such as polyethylene (PE), polypropylene (PP), or polyethylene-terephthalate (PET). The graphics sheet may even be paper, metal, painted plastic, etc, so long as that material is capable of being adhered to the middle layer 112, such as by gluing. The forward surface of the graphics sheet is preferably textured.

The graphic sheet 124 is highly visible when the fastening device has been adhered to the wall. This allows for improved display of the graphics, for purposes such as indicating the intended use of the device. For instance, in this case, the graphics is an icon 124 of a purse. But it may be an image of a purse. Or it may be text that says “purse” or “Susie's purse”. Or it may simply be text that indicates the person to whom this hook belongs, such as “Susie”.

The graphics sheet may alternatively be adaptable to being written thereon, and may contain an indicator, such as a blank horizontal line, on which the user may write information about the fastening device, such as the item that it is intended to support (i.e.“Susie's purse” or “spatula”) or the name of the owner of that fastening device (i.e. “Susie”). A hole 118 is punched slightly below center through the graphics sheet that has a just slightly larger diameter than the perimeter 122 of backing plate 104.

The middle layer 112 is preferably a polypropylene film or panel both because of its bondability to backing plate 104, and because if its flexibility. The middle layer is preferably less flexible that the very flexible adhesive layer 102 and more flexible than the substantially rigid and nonflexible backing plate 104. It is found that a polypropylene film or PET film with a thickness in the 0.25 to 0.3 two mm range provides reasonable flexibility for this.

The backing plate is bonded to the middle plate through hole 118 so that the fastening element 116 is disposed slightly below center in relation to the shared perimeter 126. This off-central position leaves a reasonably larger area on the graphics sheet, in the most visible area above the fastening element, for the graphics 124, while ensuring that the fastening element is still substantially towards the center of the device and well inboard of the shared perimeter 126, for reasons to be later explained.

In the preferred arrangement, the fastening element 116 is bonded to the middle layer be a UV glue. After applying the “raw” glue, the device is exposed to UV light for curing. The backing sheet and pad are preferably transparent, which allows UV light directed from the backing sheet side to shine through and fully expose the entire contact area between he backing plate and middle layer, for maximum bonding quality and strength.

The adhesive layer 102 is preferably made of a homogenous oil-enhanced thermoplastic rubber polymer material (TPR). A myriad of similar tacky materials may be substituted for the afore-described material, so long as those provide equivalent adherence and removal performance. The adhesive layer is permanently bound to the middle layer 112, preferably by an oil-based adhesive coating there-between, to form the pad 114.

The TPR is most preferably a styrene thermoplastic elastomer (STPE), such as a styrene-butadiene-styrene block copolymer (SBS) or a styrene-ethylene-butadiene-styrene block copolymer (SEBS). This preferably homogenous layer of thermoplastic material is impregnated with a hydrogenated naphthenic oil to obtain its permanent tackiness.

As an example, the adhesive layer may be comprised of one-hundred parts SEBS by weight, one-hundred to three-hundred parts hydrogenated naphthenic oil by weight, one-hundred to three-hundred parts white (mineral) oil by weight, less than ten parts petroleum tackifier resin by weight, and one to five parts PP resin by weight. Such SEBS may be Kraton Polymers LLC G series, or China Yueyang Baling Petrochemical Co., Ltd. Huaxing YH series, or some equivalent. Alternatively, an acceptable SBS may be Kraton Polymers LLC D series, or some equivalent.

The hydrogenated naphthenic oil preferably constitutes one-hundred-fifty to three hundred parts of the adhesive layer by weight, more preferably two-hundred to two-hundred-eighty parts by weight. This oil may be PetroChina Karamay Petrochemical Company's KNH series or NK series, or some equivalent.

The white (mineral) oil preferably constitutes one-hundred-fifty to three hundred parts of the adhesive layer by weight, more preferably two-hundred to two-hundred-eighty parts by weight.

The petroleum tackifier resin may be for example, C9 petroleum resin, C5 petroleum resin, C5/C9 copolymerized petroleum resin, or double glutaric thin (DCPD) resin. The tackifier resin preferably constitutes less than ten parts of the adhesive layer by weight, more preferably three to eight parts.

The PP resin may be improved by the addition of additives, including but not limited to plasticizers (such as paraffin or PE oligomers), antioxidants (such as calcium carbonate or silica), light stabilizers and UV stabilizers (such as UV-P and UV-320). These additives preferably constitute four to eight parts of the adhesive layer by weight.

Preferably, the adhesive strength of the adhesive layer is between 0.1 and 0.6 N/cm, the layer thickness is between 0.1 and 2.0 mm, and material has a Shore A hardness of less than 20 degrees. This adhesive can be reused many times without damage to its viscosity or reduction in its inherent adhesion. Removal of the fastening device by peeling the pad from the surface to which it has been mounted does not leave any discernable adhesive residue on the surface. In addition, the adhesive layer is easy to clean, with the dust and other impurities needing only to be wiped off with a damp cloth.

In use, the user simply peels the backing sheet from the adhesive layer and adheres the fastening device to a flat surface, such as wall, or a refrigerator or cabinet door, or such, in the orientation shown in FIGS. 2, 3 and 5, then hangs an object, such as the purse 300 shown in FIGS. 2, 3 and 5. The adherence qualities of the adhesive layer are sufficient to withstand the downward gravitational forces, parallel to surface 200, caused by the hanging weight of the object.

The disposition of the fastening element 116 inboard of the shared perimeter 126 of the device, together with the relative flexibilities of the various components, provides additional benefits in both avoiding inadvertent peeling of the device from the wall and in improving intentional peeling. The inherent adherence of adhesive layer to the wall is strongest against removal forces normal to wall and centered within the shared perimeter. In such a condition, the pad functions much like a suction cup, so that suction forces add adherence to the adhesiveness of the adhesive layer material. The adherence of the adhesive layer is weakest against removal forces that act to peel the pad from the wall at the shared perimeter, much like the removal of a suction cup.

During use, when peeling is undesirable, the gravitational forces exerted on the fastening element result in a pulling force normal to the wall at the center of the device, trying to overcome the pad's strongest adhesion. Very little of this pulling force migrates through the flexible middle layer so that virtually no removal forces are realized at the shared perimeter. If, hypothetically, the middle layer was rigid of the fastening element was adjacent the shared perimeter, it can be imagined that the pulling forces would easily inadvertently peel the device from the wall by lifting the adhesive layer from the wall at the shared perimeter, against the pad's weakest adhesion.

When such use is complete, the fastening device may be removed from the wall by simply grasping anywhere along the shared perimeter, as one removes a suction cup, and peeling the fastening device away from the wall. It is an inherent quality of the described adhesive materials that their resistance to peeling is not very strong, so long as the peeling is initiated at a point and continued across the adhered surface as a linear wave.

After peeling the fastening device from the wall, the backing sheet may be replaced to allow for indefinite storage of the fastening device prior to its next use, or the fastening device may be immediately re-adhered to some other surface. Virtually no residue is left behind on the surfaces from which the fastening device has been peeled.

While the invention has been shown and described with reference to a specific exemplary embodiment, it should be understood by those skilled in the art that various changes may be made thereto without sacrificing its material advantages. Various changes in form and detail may be made without departing from the spirit and scope of the invention, and the invention should therefore only be limited according to the following claims, including all equivalent interpretation to which they are entitled.

I claim:

1. An adhesive supporting device comprising:
an adhesive pad having an adhesive rear face for adherence to a surface and a flexible front face, the adhesive pad having a pad perimeter;
a supporting element comprising a support, and a substantially rigid backing plate integrally formed therewith or bound thereto, the backing plate having a plate perimeter smaller than the pad perimeter and a rear plate face permanently bound approximately centrally to the flexible front face of the adhesive pad such that the plate perimeter is inboard of the pad perimeter.

2. The adhesive supporting device of claim 1 further comprising a graphic sheet bound to the flexible front face.

3. The adhesive supporting device of claim 2 wherein the graphic sheet comprises graphics or text that indicates an object that the support is adapted to support.

4. The adhesive supporting device of claim 2 wherein the support is one from the group including a hook, a post, a clip, a hanger, and a shelf.

5. The adhesive supporting device of claim 1, wherein the pad comprises an elastomeric rear adhesive layer comprising the adhesive rear face, and a flexible front layer permanently laminated thereto and comprising the flexible front face.

6. The adhesive supporting device of claim 5 wherein the flexible front layer is less flexible than the elastomeric rear adhesive layer and more flexible than the substantially rigid backing plate.

7. The adhesive supporting device of claim 6 further comprising a graphic sheet bound to the flexible front face.

8. The adhesive supporting device of claim 7 wherein the graphic sheet comprises graphics or text that indicates an object that the support is adapted to support.

9. The adhesive supporting device of claim 7 wherein the support is one from the group including a hook, a post, a clip, a hanger, and a shelf.

10. The adhesive supporting device of claim 9 wherein the support and the backing plate are integrally formed of a same material.

11. An adhesive fastening device comprising:
an adhesive pad having an adhesive rear face for adherence to a surface and a flexible front face, the adhesive pad having a pad perimeter;
a fastening element comprising a fastener, and a substantially rigid backing plate integrally formed therewith or bound thereto, the backing plate having a plate perimeter smaller than the pad perimeter and a rear plate face permanently bound approximately centrally to the flexible front face of the adhesive pad such that the plate perimeter is inboard of the pad perimeter.

12. The adhesive fastening device of claim 11 further comprising a graphic sheet bound to the flexible front face.

13. The adhesive fastening device of claim 12 wherein the graphic sheet comprises graphics or text that indicates an object that the fastener is adapted to receive.

14. The adhesive fastening device of claim 12 wherein the fastener is a hook.

15. The adhesive fastening device of claim 11, wherein the pad comprises an elastomeric rear adhesive layer comprising the adhesive rear face, and a flexible front layer permanently laminated thereto and comprising the flexible front face.

16. The adhesive fastening device of claim 15 wherein the flexible front layer is less flexible than the elastomeric rear adhesive layer and more flexible than the substantially rigid backing plate.

17. The adhesive fastening device of claim 16 further comprising a graphic sheet bound to the flexible front face.

18. The adhesive fastening device of claim 17 wherein the graphic sheet comprises graphics or text that indicates an object that the fastener is adapted to receive.

19. The adhesive fastening device of claim 17 wherein the fastener is a hook.

20. The adhesive fastening device of claim 19 wherein the hook and the backing plate are integrally formed of a same material.
